(19) United States
(12) Patent Application Publication
(10) Pub. No.: US 2016/0292739 A1
(43) Pub. Date: Oct. 6, 2016

(54) MUNICIPALITY-CENTERED VIRTUAL MARKETPLACE

(71) Applicant: Tyler Crook, Herriman, UT (US)

(72) Inventor: Tyler Crook, Herriman, UT (US)

(21) Appl. No.: 14/673,526

(22) Filed: Mar. 30, 2015

(51) Int. Cl. G06Q 30/02; G06Q 50/26

(52) U.S. Cl. CPC G06Q 30/0261; G06Q 50/26

(57) ABSTRACT

A method and computer program product are disclosed for creating a municipality centered virtual marketplace via a computer network including receiving and sending municipality-based content from a municipality or chamber of commerce to the virtual marketplace. Business based content is sent and received from a business located within the municipality to the virtual marketplace regarding goods or services offered by the business. Customer based content is sent and received from a customer regarding the municipality based content and the business based content from the virtual marketplace. Transactions between the customer and the business are processed for at least one of the municipality sponsored incentives to patronize local businesses, promotions, advertisements and special deals offered by the business on the municipality centered virtual marketplace. Information relating to the transaction is communicated to the businesses and the municipality.

### BACKGROUND OF THE INVENTION

1. Field of the Invention

This invention relates generally to cellular phone based user applications (also known as “apps”), and more particularly relates to a web-based application for facilitating the promotion of local business by municipalities or chambers of commerce.

2. Description of the Related Art

In today's world of electronic commerce, the shopper's experience in finding a desired product or service can be as simple as inputting search terms into an internet search engine, scanning the results of the search to find a vendor that meets the shopper's requirements, placing an order on the chosen vendor's website, and waiting for the order to be delivered to the shopper. While the simplicity and efficiency of such a virtual shopping experience offers some advantages to a shopper, there are also disadvantages to those users who wish to support businesses within their own municipalities and communities. For instance, smaller local vendors often do not show up in a search engine's results or may be relegated to a listing position within the search results that is well below other vendors with a more favored search engine status. Thus, finding a local vendor or business may be a more difficult and frustrating experience to the shopper leading the shopper to choose a non-locally based vendor when a civic minded shopper would gladly support a local business otherwise.

Additionally, local municipal governments recognize the value of attracting and directing businesses to their communities so as to maintain jobs and tax dollars within their local municipalities. Relying on unrelated and often disinterested third party internet search engines to highlight a municipality's local businesses puts the interests of the municipality at the mercy of the search engine's algorithms which might direct shoppers and their tax dollars to non-municipality based vendors.

Some municipal governments run internet websites that provide information about the municipality and local community. These websites often allow the municipality to distribute information that is important for the community such as the community calendar, sporting events, and emergency news. These websites may even highlight local businesses in an effort to push business to their communities. Unfortunately, such county or city websites usually provide limited accessibility to a user on the go who wants to access information via a handheld portable device such as a cellular telephone. Additionally, city and county websites don't offer the user the online comparison shopping experience of an internet search engine. Nor do these websites allow highlighted businesses the opportunity to advertise or offer promotions as might be found in internet search results.

This invention/cell phone app will create a municipality centered virtual marketplace that allows a municipality to distribute information to residents, allows shoppers to access and evaluate local businesses, and allows local businesses to promote and advertise goods and services.

### SUMMARY OF THE INVENTION

From the foregoing discussion, it should be apparent that a need exists for a municipality-centered virtual market place that combines information from the municipality and businesses located within the municipality so as to promote, direct traffic to, and even allow the municipality to sponsor incentives that encourage patronage of the local businesses. Beneficially, such a virtual marketplace would allow municipalities to partner with local businesses to promote commerce within the municipality, thereby increasing financial revenues to both the business, through sales, and the municipality via tax revenue.

The present invention has been developed in response to the problems and needs in the art that have not yet been fully solved by currently available apparati and methods. Accordingly, the present invention has been developed to provide A method for creating a municipality centered virtual marketplace via a computer network, comprising: receiving and sending municipality based content from a municipality to the virtual marketplace, the municipality based content including information relating to operation and governance of the municipality, and municipality sponsored incentives to patronize local businesses; receiving and sending business based content from a business located within the municipality to the virtual marketplace regarding goods or services offered by the business, the business based content including acceptance of the municipality sponsored incentives to patronize local businesses, promotions, advertisements and special deals available only from the municipality centered virtual marketplace; receiving and sending customer based content from a customer regarding the municipality based content and the business based content from the virtual marketplace, the customer based content including the customer use of the municipality sponsored incentives to patronize local businesses, and the business promotions, advertisements and special deals available only from the municipality centered virtual marketplace; processing a transaction between the customer and the business for at least one of the municipality sponsored incentives to patronize local businesses, promotions, advertisements and special deals offered by the business on the municipality centered virtual marketplace; and communicating to the business and the municipality information relating to the transaction.

The computer network may further comprise: one or more processors; and a computer readable memory accessible by the one or more processors, the computer readable memory storing programming instructions for a municipality based virtual marketplace system.

The method may further comprise: connecting to a remote server containing data that either stores or processes the data to be used on a mobile handheld wireless computing device for sending and receiving content to the virtual marketplace.

The mobile handheld wireless computing device is selected from the group consisting of a mobile phone, a cellular phone, a satellite phone, a mobile handheld electronic organizer, a mobile electronic tablet, a laptop computer, any other Internet-connected personal device, and combinations thereof.

The method may further comprise: accessing a user interface running on a mobile device that connects to a remote server containing data that used on a mobile device for sending and receiving content to the virtual marketplace.

The interface may include or comprise a graphical user interface with icons providing access to the municipal based content and the business based content.

The icons may be selected from the group consisting of calendar and community events, municipality announcements, emergency messages, search engines, social media based rewards, food and grocery deals, general deals, home improvement deals, reward redemption, municipality and business related statistics, school information, user profile, user registration and login, entertainment, business listings, advertisements, promotions, coupons, patron punch cards, and combinations thereof.

The municipality may sponsor incentives to patronize a local business include an electronic punch card allowing the customer to record the number of times the customer patronizes a business and receive a reward after a designated number is achieved.

The municipality-centered virtual marketplace may track and record punch cards for a plurality of local businesses located within the municipality that are participating in the municipality sponsored incentives.

The municipality-centered market place may further comprise a rewards claim page and transfers an achieved reward from a completed electronic punch card to the rewards claim page when the conditions of the electronic punch card are completed.

The method may further comprise: receiving point of sale information from a municipality located business indicating a qualified transaction at the business was completed; sending a code to the consumer acknowledging the transaction; and recording the transaction on an electronic punch card accessible via the virtual market place after the consumer has redeemed the code.

The municipality may sponsor incentives to patronize a local business include offering deals on goods and services via the municipality based market place that are redeemable at a local businesses located within the municipality.

The municipality may sponsor incentives to patronize a local business include offering deals on goods and services in exchange for reviews on social media related websites accessible to the municipality based market place, the rewards being redeemable at a local businesses located within the municipality when the review is posted to a social media website.

In some embodiments, the method further comprises: sending an offer from the municipality centered virtual market place for a sponsored incentive deal related to a local business in exchange for a review on a social media website; receiving data from the social media website that a review has been posted by a consumer for the local business; and recording the earning of the reward to an account of the consumer and providing an electronic redemption to the consumer.

The method may further comprise: receiving search data regarding businesses located within the municipality from a user interface; and sorting search results so as to feature businesses that pay to be at the top of the results list first the results with a secondary listing of businesses that have registered with the municipality centered virtual market place, and a third listing of business that are located within the municipality but have not registered with the municipality centered virtual market place.

A computer system for providing services or goods via an online marketplace is also disclosed, the system comprising: one or more processors; a computer readable memory accessible by the one or more processors, the computer readable memory storing programming instructions for creating a municipality based virtual marketplace system, comprising: receiving and sending municipality based content from a municipality to the virtual marketplace, the municipality based content including information relating to operation and governance of the municipality, and municipality sponsored incentives to patronize local businesses; receiving and sending business based content from a business located within the municipality to the virtual marketplace regarding goods or services offered by the business, the business based content including acceptance of the municipality sponsored incentives to patronize local businesses, promotions, advertisements and special deals available only from the municipality centered virtual marketplace; receiving and sending customer based content from a customer regarding the municipality based content and the business based content from the virtual marketplace, the customer based content including the customer use of the municipality sponsored incentives to patronize local businesses, and the business promotions, advertisements and special deals available only from the municipality centered virtual marketplace; processing a transaction between the customer and the business for at least one of the municipality sponsored incentives to patronize local businesses, promotions, advertisements and special deals offered by the business on the municipality centered virtual marketplace; and communicating to the business and the municipality information relating to the transaction.

The programming instructions for creating a municipality based virtual marketplace system may further comprise: receiving point of sale information from a municipality located business indicating a qualified transaction at the business was completed; sending a code to the consumer acknowledging the transaction; and recording the transaction on an electronic punch care accessible via the virtual market place after the consumer has redeemed the code.

In alternative embodiments, the programming instructions for creating a municipality based virtual marketplace system may further comprise: sending an offer from the municipality centered virtual market place for a sponsored incentive deal related to a local business in exchange for a review on a social media website; receiving data from the social media website that a review has been posted by a consumer for the local business; and recording the earning of the reward to an account of the consumer and providing an electronic redemption to the consumer.

The programming instructions for creating a municipality based virtual marketplace system may further comprise: receiving search data regarding businesses located within the municipality from a user interface; and sorting search results so as to feature businesses that pay to be at the top of the results list first the results with a secondary listing of businesses that have registered with the municipality centered virtual market place, and a third listing of business that are located within the municipality but have not registered with the municipality centered virtual market place.

These features and advantages of the present invention will become more fully apparent from the following description and appended claims, or may be learned by the practice of the invention as set forth hereinafter

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is flow chart showing a method of creating a municipality centered virtual marketplace in accordance with an embodiment of the present invention;

FIG. 2 is a schematic layout of a search engine returning search results from the municipality centered virtual marketplace of FIG. 1;

FIG. 3 is a flow chart showing use of a rewards incentive program in the municipality centered virtual marketplace of FIG. 1;

FIG. 4 is a flow chart showing use of a social media reward incentive program in the municipality centered virtual marketplace of FIG. 1;

FIG. 5 is a schematic layout of user interface for a mobile device that accesses the municipality centered virtual marketplace of FIG. 1;

FIG. 6 is a schematic diagram of a computer network used to create a municipality centered virtual marketplace in accordance with another embodiment of the present invention; and

FIG. 7 illustrates a web browser having virtual controls in accordance with the present invention.

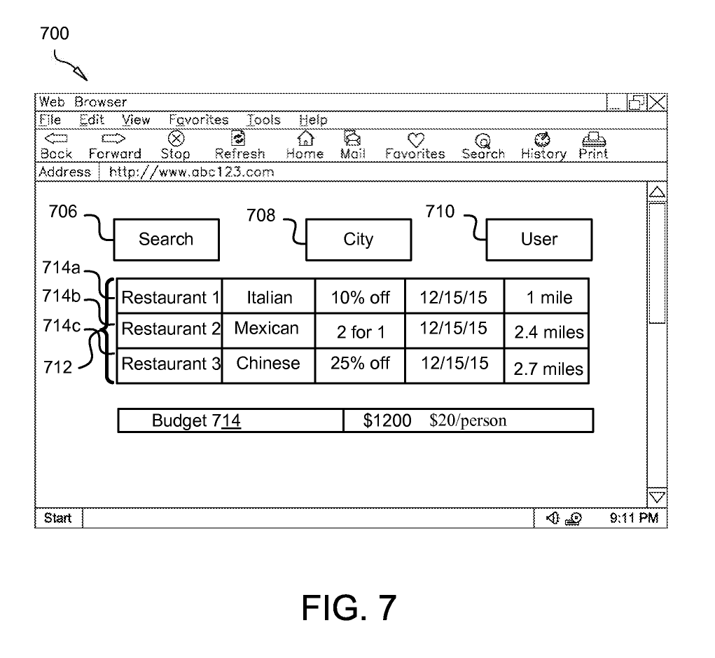

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

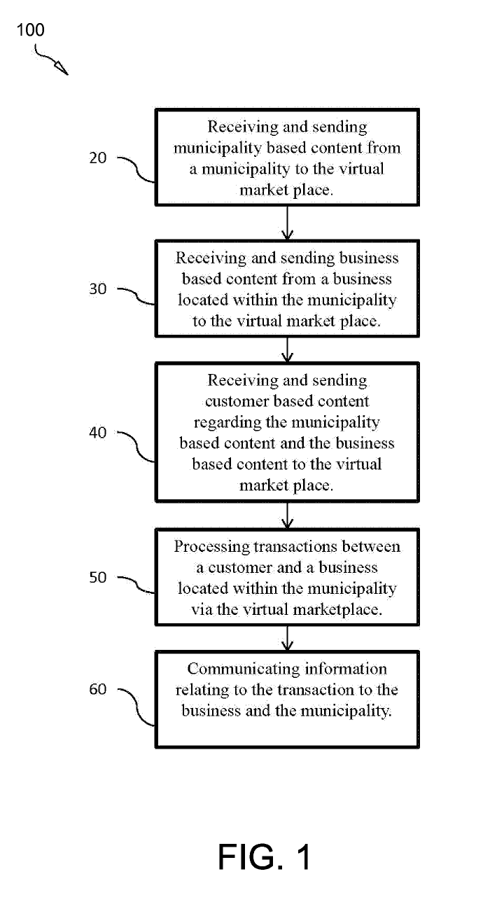

As illustrated in FIG. 1, a method for creating a municipality centered virtual marketplace via a computer network, indicated generally at 10, is shown in accordance with an embodiment of the present invention for allowing a municipality to combine information and data about the municipality and businesses located within the municipality into a virtual marketplace.

For the purposes of this specification, the term “municipality” includes municipalities, chambers of commerce, cities, townships, unincorporated townships, states, nation states, and other form of government or organization existing to promote the interests of business in a locality.

The method 10 includes receiving and sending municipality based content from a municipality to the virtual marketplace, shown at 20. Business based content can be received and sent from a business located within the municipality to the virtual marketplace, as shown at 30. Customer based content can be received and sent from a customer regarding the municipality based content and the business based content from the virtual marketplace, as shown at 40. The method can also include processing transactions between a customer and a local business, shown at 50, and communicating information relating to the transaction to the business and the municipality, shown at 60.

The municipality based content in the step of receiving and sending municipality based content from a municipality to the virtual marketplace 20 can include information relating to operation and governance of the municipality, and emergency messages from the municipality. Additionally, the municipality based content can include municipality sponsored incentives offered to potential customers, such as users of the virtual market place, to patronize local businesses.

The business based content in the step of receiving and sending business based content from a business located within the municipality 30 to the virtual marketplace can include information and data regarding goods or services offered by the business. Additionally, the business based content can include acceptance by the business of the municipality sponsored incentives to patronize local businesses, promotions, advertisements, and special deals available only from the municipality centered virtual marketplace.

The customer based content in the step of receiving and sending customer based content from a customer regarding the municipality based content and the business based content from the virtual marketplace 40 can include information and data regarding a customer's access and use of the municipality sponsored incentives to patronize local businesses. Additionally, the customer based content can include information and data regarding the customer's access and use of business promotions, advertisements and special deals available only from the municipality centered virtual marketplace.

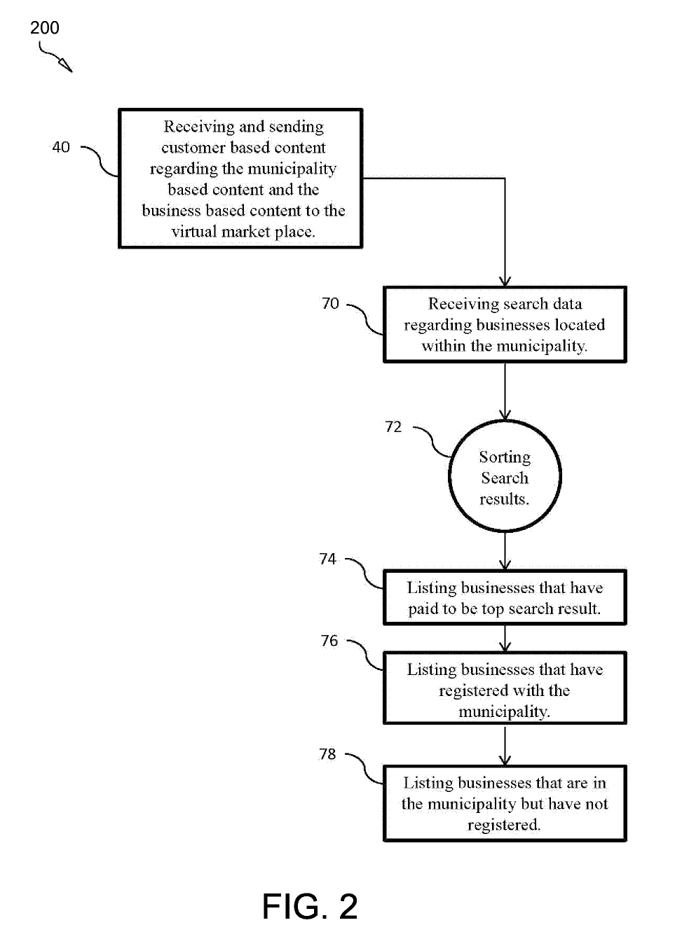

As illustrated in FIG. 2, the step of receiving and sending customer based content from a customer regarding the municipality based content and the business based content from the virtual marketplace 40 can include receiving search data regarding businesses located within the municipality from a user interface, shown at 70. The municipality centered virtual marketplace can sort search results based on an inquiry from a customer, shown at 72, so as to feature businesses that pay the municipality to be at the top of the results list first, shown at 74. Listings of businesses that have registered with the municipality centered virtual market place but have not paid for a top listing spot can be positioned in secondary listing spot, shown at 76. Businesses that are located within the municipality but have not registered with the municipality centered virtual marketplace can be listed in a third listing spot, shown at 78.

Returning to FIG. 1, the step of processing a transaction between the customer and the business 50 can include processing and transforming information and data for at least one of the municipality sponsored incentives to patronize local businesses, promotions, advertisements and special deals offered by the business on the municipality centered virtual marketplace.

The step of communicating to the business and the municipality information relating to the transaction 60 can include information and data related to a sale between the business and customer. Additionally, information and data regarding access and use of a municipality sponsored incentives to patronize local businesses, promotions, advertisements and special deals offered by the business on the municipality centered virtual marketplace can be communicated between the business and the municipality to allow the business and municipality to monitor, track, evaluate and measure the effectiveness of the business's participation in the municipality centered virtual marketplace.

In various embodiments, locally-based businesses remit payment for inclusion in the marketplace to either a municipality or an organization managing the marketplace.

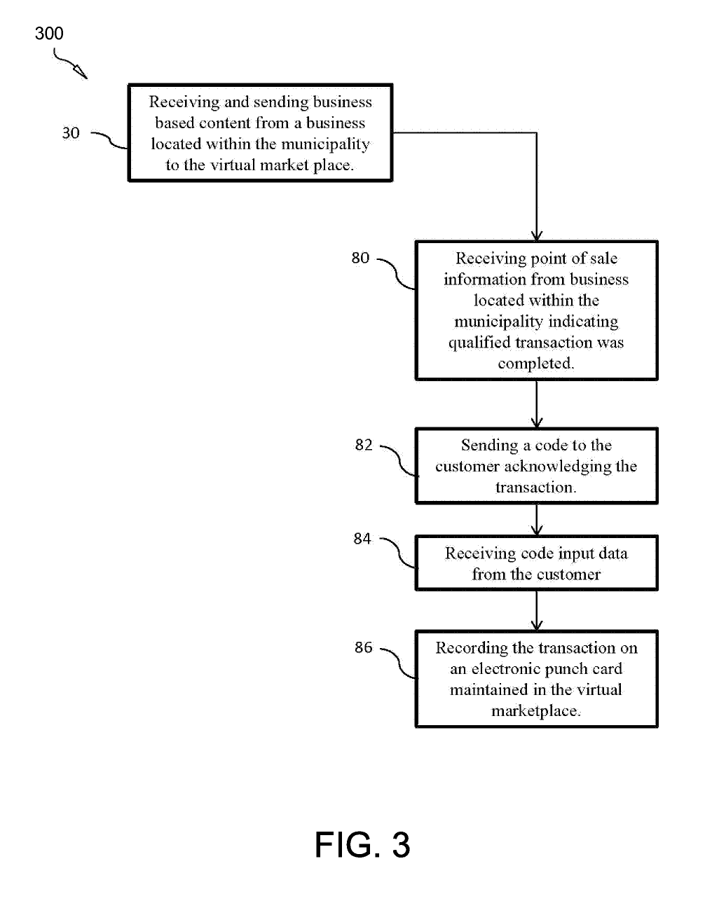

As illustrated in FIG. 3, the step of receiving and sending business based content to the virtual marketplace can also include receiving point of sale information from a municipality located business indicating a qualified transaction at the business was completed, shown at 80. A code can be sent to the consumer acknowledging the transaction, shown at 82. The transaction can be recorded on an electronic punch card, shown at 84, accessible via the virtual marketplace after the consumer has input the code to the virtual marketplace, shown at 86.

In this embodiment, the municipality sponsored incentives to patronize a local business can include an electronic punch card that allows the customer to record the number of times the customer patronizes a business and receive a reward after a designated number is achieved. The municipality centered virtual marketplace can track and record punch card offers for each customer using the virtual market place and for a plurality of local businesses located within the municipality that are participating in the municipality sponsored incentives. The municipality centered market place can also includes a rewards claim page and can transfer an achieved reward from a completed electronic punch card to the rewards claim page when the conditions of the electronic punch card are completed.

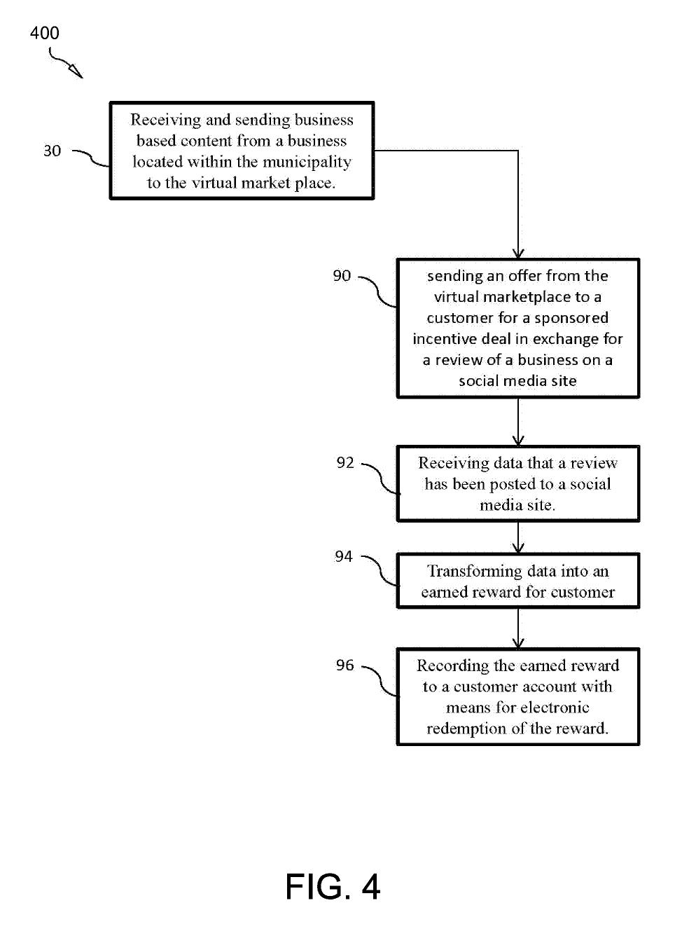

As illustrated in FIG. 4, the step of receiving and sending business based content to the virtual marketplace can also include sending an offer from the municipality centered virtual marketplace to a customer for a sponsored incentive deal related to a local business in exchange for a review of the business on a social media website, shown at 90. Data from the social media website can be received by the virtual marketplace indicating that a review on an approved social media site has been posted by a consumer for the local business, shown at 92. The virtual marketplace can transform the social media data into an earned reward for the customer, shown at 94. The earned reward can be recorded to an account of the consumer along with a means for electronic redemption that can be used by the customer to collect the reward, shown at 96.

In this embodiment, the municipality sponsored incentives to patronize a local business can include offering deals on goods and services via the municipality based market place that are redeemable at a local businesses located within the municipality. The municipality sponsored incentives to patronize a local business can include offering deals on goods and services in exchange for reviews on social media related websites accessible to the municipality based market place. The rewards can be redeemed at a local businesses located within the municipality after the review is posted to a social media website.

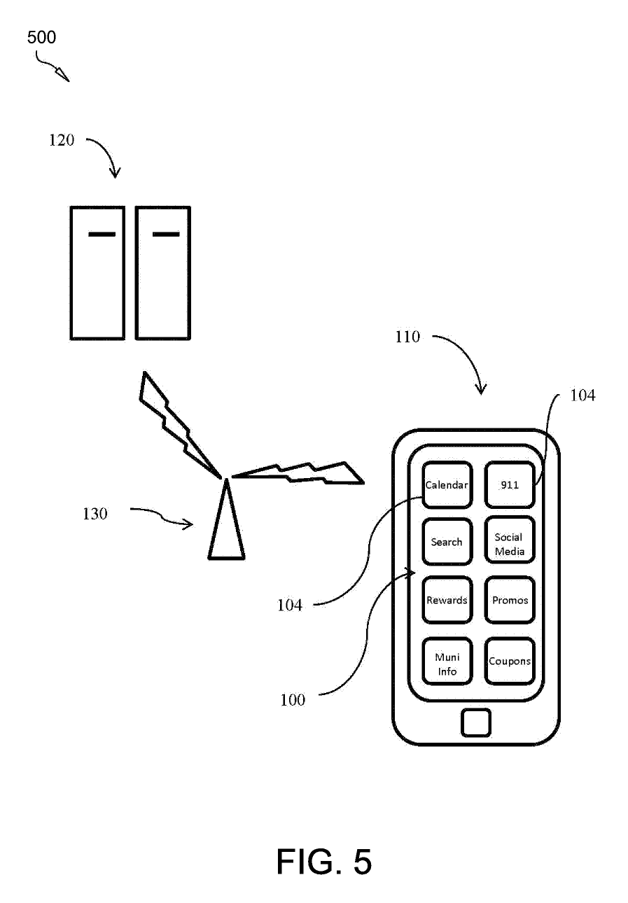

As illustrated in FIG. 5, the method 10 of FIG. 1 can also include accessing a user interface, indicated generally at 100, running on a mobile device, indicated generally at 110, that connects to a remote server, indicated generally at 120, via a wireless access point, indicated generally at 130. The remote server 120 can contain data that can be used on a mobile device 110 for sending and receiving content to the virtual marketplace. The interface 100 can be a graphical user interface with icons 104 providing access to the municipal based content and the business based content. The icons 104 can provide access to information and data regarding calendar and community events, municipality announcements, emergency messages, search engines, social media based rewards, food and grocery deals, general deals, home improvement deals, reward redemption, municipality and business related statistics, school information, user profile, user registration and login, entertainment, business listings, advertisements, promotions, coupons, patron punch cards, and the like.

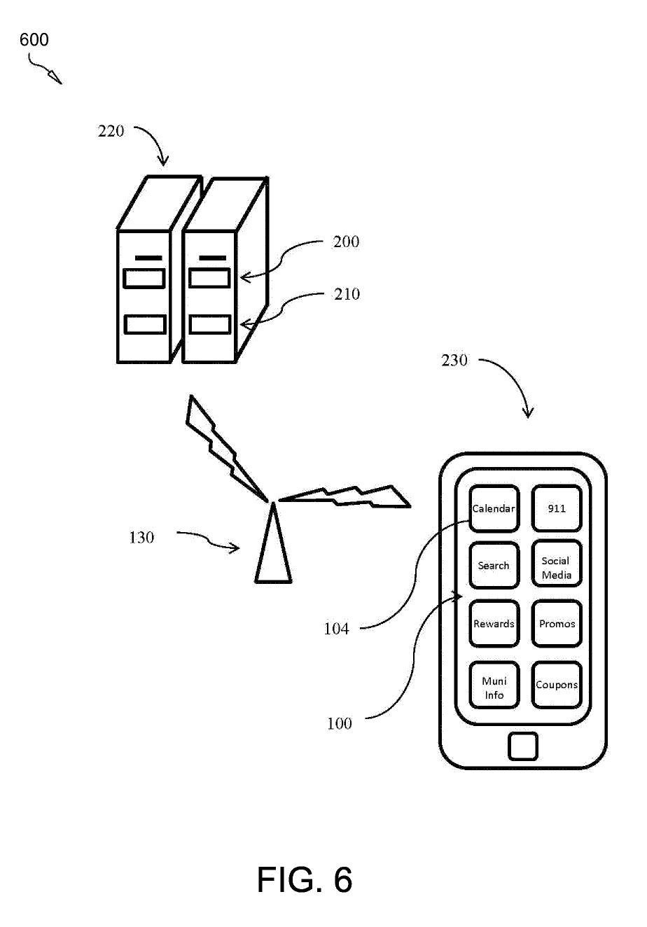

As illustrated in FIG. 6, the computer network can include one or more processors, indicated generally at 200. Additionally, the computer network can include a computer readable memory, indicated generally at 210, that is accessible by the one or more processors, the computer readable memory storing programming instructions for a municipality based virtual marketplace system. The programming instructions can implement the method 10 shown in FIG. 1.

Additionally, the processors and computer readable memory can connect to a remote server, indicated generally at 220, via a wireless access point 130. The remote server 220 can contain data that either stores or processes the data to be used on a mobile handheld wireless computing device, indicated generally at 230, for sending and receiving content to the virtual marketplace. The mobile handheld wireless computing device 230 can include a mobile phone, a cellular phone, a satellite phone, a mobile handheld electronic organizer, a mobile electronic tablet, a laptop computer, any other internet-connected personal electronic device, and the like.

Figured 7 illustrates a display and virtual controls 700 a web browser having virtual controls in accordance with the present invention. The display and virtual controls 700 comprise a search button 706, a sponsoring municipality or city 708, the name of a user 710, offers of nearby businesses 714a-c displayed in a group 712, and a budget 714 for the user.

A user of the computer program product may search for promotions of a specific kind or type using the search control 706. A user may switch the promotions displayed from those of one city to another using the city button 708. A user's name may displayed and editable using a name control 710.

In various embodiments, the promotions offered by the city in response to selection of controls 706-710 results in a group 712 of promotions being displayed. The promotions in group 712 include offers 714.

The offers 714 may comprise a business name in a first column or row, a type of product or service offered by said business in another column or row, a discount offered, an expiration date of the offer 714, and a distance to the business making the offer 714 from a user's location. This is only one exemplar embodiment of the present invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for creating a municipality-centered virtual marketplace via a computer network, comprising:
receiving and sending municipality-based content from a municipality to the virtual marketplace, the municipality based content including information relating to operation and governance of the municipality, and municipality sponsored incentives to patronize local businesses;
receiving and sending business based content from a business located within the municipality to the virtual marketplace regarding goods or services offered by the business, the business based content including acceptance of the municipality sponsored incentives to patronize local businesses, promotions, advertisements and special deals available only from the municipality centered virtual marketplace;
receiving and sending customer based content from a customer regarding the municipality based content and the business based content from the virtual marketplace, the customer based content including the customer use of the municipality sponsored incentives to patronize local businesses, and the business promotions, advertisements and special deals available only from the municipality centered virtual marketplace;
processing a transaction between the customer and the business for at least one of the municipality sponsored incentives to patronize local businesses, promotions, advertisements and special deals offered by the business on the municipality centered virtual marketplace; and
communicating to the business and the municipality information relating to the transaction.

2. A method in accordance with claim 1, the computer network further comprising:
one or more processors; and
a computer readable memory accessible by the one or more processors, the computer readable memory storing programming instructions for a municipality based virtual marketplace system.

3. A method in accordance with claim 1, further comprising:
connecting to a remote server containing data that either stores or processes the data to be used on a mobile handheld wireless computing device for sending and receiving content to the virtual marketplace.

4. A method in accordance with claim 1, wherein the mobile handheld wireless computing device is selected from the group consisting of a mobile phone, a cellular phone, a satellite phone, a mobile handheld electronic organizer, an mobile electronic tablet, a laptop computer, and combinations thereof.

5. A method in accordance with claim 1, further comprising: accessing a user interface running on a mobile device that connects to a remote server containing data that used on a mobile device for sending and receiving content to the virtual marketplace.

6. A method in accordance with claim 5, wherein the interface includes a graphical user interface with icons providing access to the municipal based content and the business based content.

7. A method in accordance with claim 5 wherein the icons are selected from the group consisting of calendar and community events, municipality announcements, emergency messages, search engines, social media based rewards, food and grocery deals, general deals, home improvement deals, reward redemption, municipality and business related statistics, school information, user profile, user registration and login, entertainment, business listings, advertisements, promotions, coupons, patron punch cards, and combinations thereof.

8. A method in accordance with claim 1, wherein the municipality sponsored incentives to patronize a local business include an electronic punch card allowing the customer to record the number of times the customer patronizes a business and receive a reward after a designated number is achieved.

9. A method in accordance with claim 8, wherein the municipality centered virtual marketplace tracks and records punch cards for a plurality of local businesses located within the municipality that are participating in the municipality sponsored incentives.

10. A method in accordance with claim 8, wherein the municipality centered market place further includes a rewards claim page and transfers an achieved reward from a completed electronic punch card to the rewards claim page when the conditions of the electronic punch card are completed.

11. A method in accordance with claim 1, further comprising:
receiving point of sale information from a municipality located business indicating a qualified transaction at the business was completed;
sending a code to the consumer acknowledging the transaction; and
recording the transaction on an electronic punch card accessible via the virtual market place after the consumer has redeemed the code.

12. A method in accordance with claim 1, wherein the municipality sponsored incentives to patronize a local business include offering deals on goods and services via the municipality based market place that are redeemable at a local businesses located within the municipality.

13. A method in accordance with claim 1, wherein the municipality sponsored incentives to patronize a local business include offering deals on goods and services in exchange for reviews on social media related websites accessible to the municipality based market place, the rewards being redeemable at a local businesses located within the municipality when the review is posted to a social media website.

14. A method in accordance with claim 1, further comprising:
sending an offer from the municipality centered virtual market place for a sponsored incentive deal related to a local business in exchange for a review on a social media website;
receiving data from the social media website that a review has been posted by a consumer for the local business; and
recording the earning of the reward to an account of the consumer and providing an electronic redemption to the consumer.

15. A method in accordance with claim 1, further comprising:
receiving search data regarding businesses located within the municipality from a user interface; and
sorting search results so as to feature businesses that pay to be at the top of the results list first the results with a secondary listing of businesses that have registered with the municipality centered virtual market place, and a third listing of business that are located within the municipality but have not registered with the municipality centered virtual market place.

16. A computer system for providing services or goods via an online marketplace, the system comprising:
one or more processors;
a computer readable memory accessible by the one or more processors, the computer readable memory storing programming instructions for creating a municipality based virtual marketplace system, comprising:
receiving and sending municipality based content from a municipality to the virtual marketplace, the municipality based content including information relating to operation and governance of the municipality, and municipality sponsored incentives to patronize local businesses;
receiving and sending business based content from a business located within the municipality to the virtual marketplace regarding goods or services offered by the business, the business based content including acceptance of the municipality sponsored incentives to patronize local businesses, promotions, advertisements and special deals available only from the municipality centered virtual marketplace;
receiving and sending customer based content from a customer regarding the municipality based content and the business based content from the virtual marketplace, the customer based content including the customer use of the municipality sponsored incentives to patronize local businesses, and the business promotions, advertisements and special deals available only from the municipality centered virtual marketplace;
processing a transaction between the customer and the business for at least one of the municipality sponsored incentives to patronize local businesses, promotions, advertisements and special deals offered by the business on the municipality centered virtual marketplace; and
communicating to the business and the municipality information relating to the transaction.

17. The computer program product of claim 16, the programming instructions for creating a municipality based virtual marketplace system further comprising:
receiving point of sale information from a municipality located business indicating a qualified transaction at the business was completed;
sending a code to the consumer acknowledging the transaction; and
recording the transaction on an electronic punch care accessible via the virtual market place after the consumer has redeemed the code.

18. A method in accordance with claim 16, the programming instructions for creating a municipality based virtual marketplace system further comprising:
sending an offer from the municipality centered virtual market place for a sponsored incentive deal related to a local business in exchange for a review on a social media website;
receiving data from the social media website that a review has been posted by a consumer for the local business; and
recording the earning of the reward to an account of the consumer and providing an electronic redemption to the consumer.

19. A method in accordance with claim 16, the programming instructions for creating a municipality based virtual marketplace system further comprising:
receiving search data regarding businesses located within the municipality from a user interface; and
sorting search results so as to feature businesses that pay to be at the top of the results list first the results with a secondary listing of businesses that have registered with the municipality centered virtual market place, and a third listing of business that are located within the municipality buy have not registered with the municipality centered virtual market place.
